(19) United States
(12) Patent Application Publication
(10) Pub. No.: US 2014/0090302 A1
(43) Pub. Date: Apr. 3, 2014

(54) SLIDING DOOR STRUCTURE FOR VEHICLE

(71) Applicant: HYUNDAI MOTOR COMPANY, Seoul (KR)

(72) Inventor: Young Rock KIM, Gwangmyeong-si (KR)

(73) Assignee: Hyundai Motor Company, Seoul (KR)

(21) Appl. No.: 13/688,852

(22) Filed: Nov. 29, 2012

(30) Foreign Application Priority Data
Sep. 28, 2012 (KR) 10-2012-0108554

(51) Int. Cl. E05C 17/60

(52) U.S. Cl. CPC E05D 13/04
USPC 49/449

(57) ABSTRACT

A sliding door structure for a vehicle is provided, which includes a door panel member including a door inner panel and a door latch reinforcement, having a refractive part, and slidably provided in the sliding door; a pole installed at the refractive part of the door panel member; and a side panel corresponding to the door panel member, provided on the side of the vehicle, having an inserting hole into which the pole is inserted. It is possible to improve marketable quality and safety and ensure rigidity to increase performance of a vehicle body by preventing separation from a vehicle when a sliding door for the vehicle opens and closes.

### CROSS-REFERENCE TO RELATED APPLICATION

The present application claims priority of Korean Patent Application Number 10-2012-0108554 filed Sep. 28, 2012, the entire contents of which application is incorporated herein for all purposes by this reference.

### BACKGROUND OF INVENTION

1. Field of Invention

The present invention relates to a sliding door structure for a vehicle, and more particularly, to a sliding door structure for a vehicle for preventing separation from the vehicle when the sliding door opens and closes.

2. Description of Related Art

Generally, a door for a vehicle has an opening and closing function so that a passenger enters and a function to protect the passenger and a vehicle room from rain, wind, and accident and is divided into a door with a chassis and a chassis-less door according to a type of door panel and frame existence and non existence. Further, the door for a vehicle is classified into a front-hinge and rear-open type in which a hinge is disposed at the front and the rear portion opens, a girling door which has a loop or front pillar hinge and vertically opens and closes, and a sliding door (a side door of a van) which movably opens and closes along the side of the vehicle, according to an opening direction of the door.

Among them, a van carrying more passengers and goods than a motor car adopts a sliding door and recently, the sliding door is applied to the motor car. In the case where the passenger gets in or out at the side of the vehicle, when the passenger pushes the door, the door moves in a rear direction while moving along a rail, and then when the passenger gets in or out of the vehicle, the door returns to an original position.

Further, in the sliding door, when the door moves in the rear direction to open, the door includes a locking device as a safety device so as not to close of itself after sliding, and as a result, the passenger easily gets in or out of the vehicle.

FIGS. 1A and 1B are diagrams illustrating a sliding door for a vehicle according to the prior art and FIGS. 2A, 2B and 2C are a diagrams illustrating a problem of a sliding door for a vehicle according to the prior art.

As illustrated in FIG. 1 A, in the sliding door structure for a vehicle according to the prior art, a pole 11 is formed at a vehicle body 10, a hole 21 corresponding to the pole 11 of the vehicle body 10 side is formed in the door 20, and the pole 11 is inserted into the hole 21 according to a sliding open and close of the door.

As illustrated in FIG. 1B, a rail 30 preventing a roller from being removed during door sliding is provided at the top, the middle, and the bottom of the vehicle body 10.

However, in the prior art, as illustrated in FIGS. 2A, 2B and 2C, since a descending direction of a center rail C is inevitable due to installation of a quarter glass and a rear combination lamp and a distance between the top of the rear door and a support point is increased, a phenomenon in which the rear of the panel of the door side is deformed during use occurs. As a result, since a phenomenon in which the door is separated from the vehicle body occurs, there is a problem in that safety and marketable quality deteriorate.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, various aspects of the present invention have been made to solve the above-mentioned problems occurring in the prior art while advantages achieved by the prior art are maintained intact.

Various aspects of the present invention provide for a sliding door structure for a vehicle capable of preventing separation from the vehicle when the sliding door opens and closes.

Various aspects of the present invention provide for a sliding door structure for a vehicle, including: a door panel member including a door inner panel and a door latch reinforcement, having a refractive part, and slidably provided in the sliding door; a pole installed at the refractive part of the door panel member; and a side panel corresponding to the door panel member, provided on the side of the vehicle, having an inserting hole into which the pole is inserted.

In this case, an inner panel may be installed on the inside of the side panel.

Further, a plate may be additionally installed on the door panel member, and the pole may be installed on the plate.

The pole may be installed to be inclined to the plate, and the inserting hole may be formed in a shape corresponding to the pole.

Various aspects of the present invention provide for a sliding door structure for a vehicle, including: a pole installed on a side panel; a door panel member including a roller arm so as to be slidable along the side panel; and an inserting hole formed in roller arm into which the pole is inserted.

In this case, a plate may be additionally installed on the side panel, and the pole may be installed on the plate.

Further, the pole may be installed to be inclined to the side panel, and the inserting hole may also be formed in a shape corresponding to the pole.

The present methods and apparatuses have other features and advantages apparent from the accompanying drawings, incorporated herein, and below Detailed Description, which together serve to explain certain principles of the present invention.

### BRIEF DESCRIPTION OF THE DRAWINGS

FIGS. 1A and 1B are diagrams illustrating a sliding door for a vehicle according to the prior art.

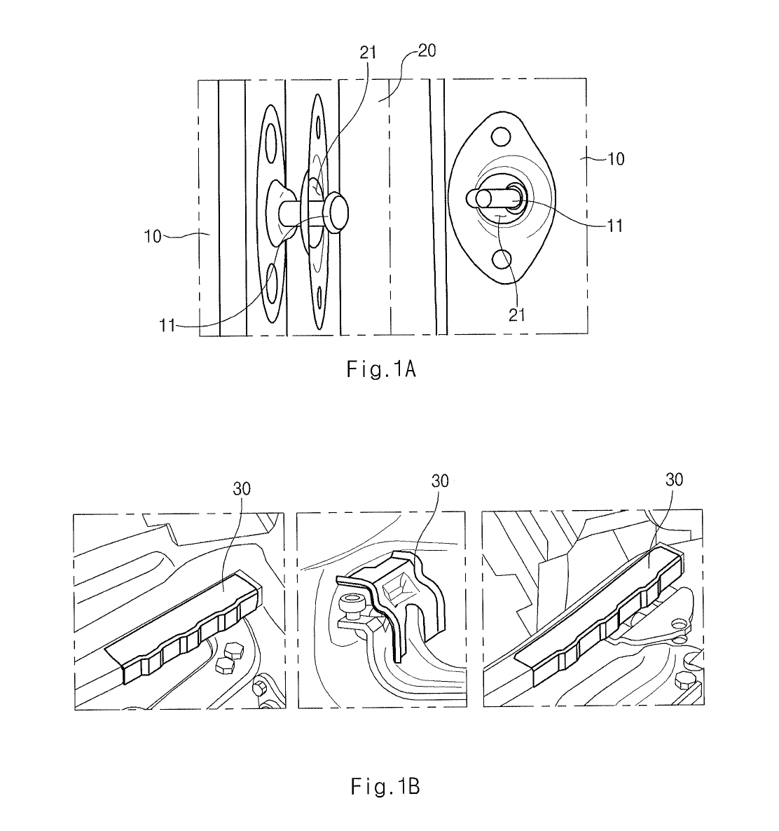

FIGS. 2A, 2B and 2C are diagrams illustrating a problem of a sliding door structure for a vehicle according to the prior art.

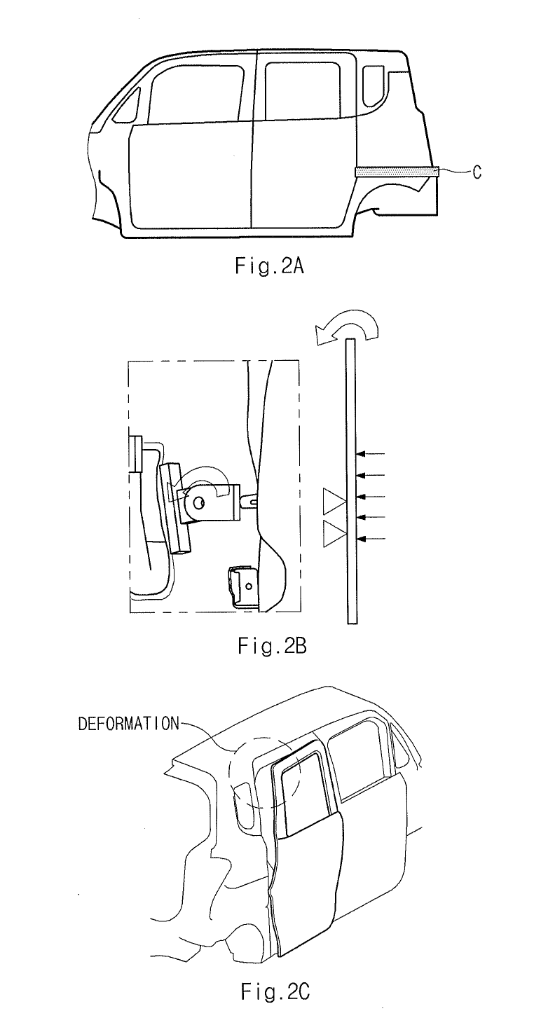

FIG. 3 is a diagram illustrating an exemplary sliding door structure for a vehicle according to the present invention.

FIG. 4 is a cross-sectional view illustrating an exemplary sliding door structure for a vehicle according to the present invention.

FIG. 5 is a cross-sectional view illustrating an exemplary inserting hole in the sliding door structure for a vehicle according to the present invention.

FIG. 6 is a diagram illustrating an exemplary sliding door structure for a vehicle according to the present invention.

FIG. 7 is a cross-sectional view illustrating an exemplary sliding door structure for a vehicle according to the present invention.

FIG. 8 is a diagram illustrating an exemplary inserting hole in the sliding door structure for a vehicle according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

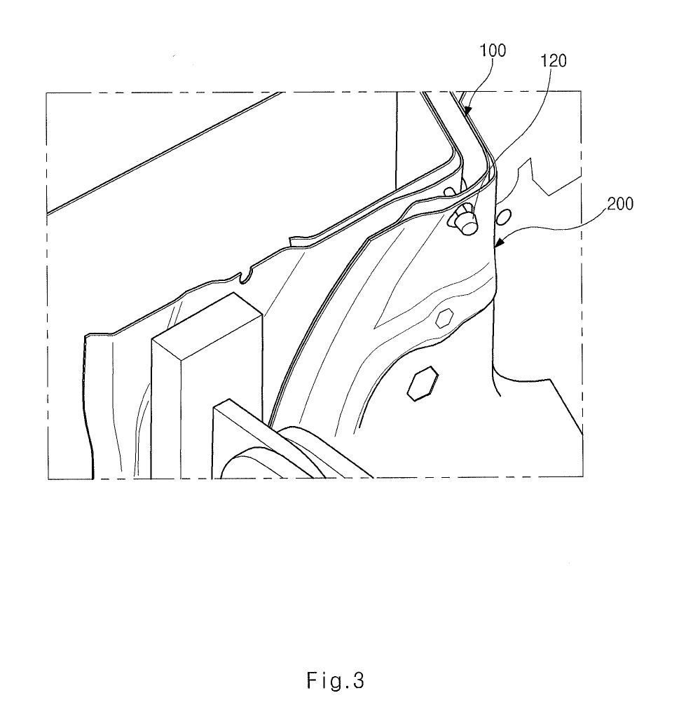

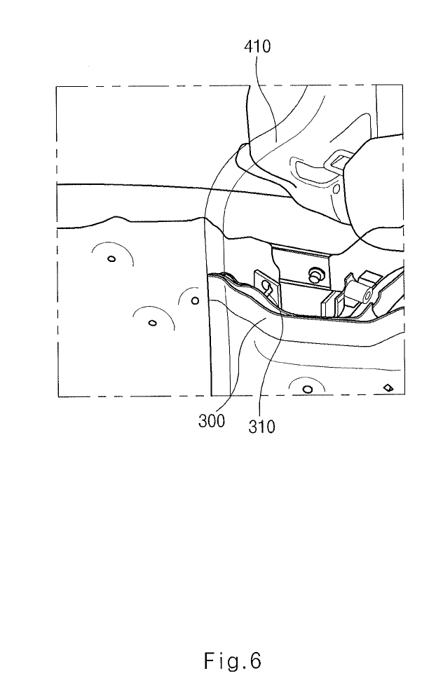

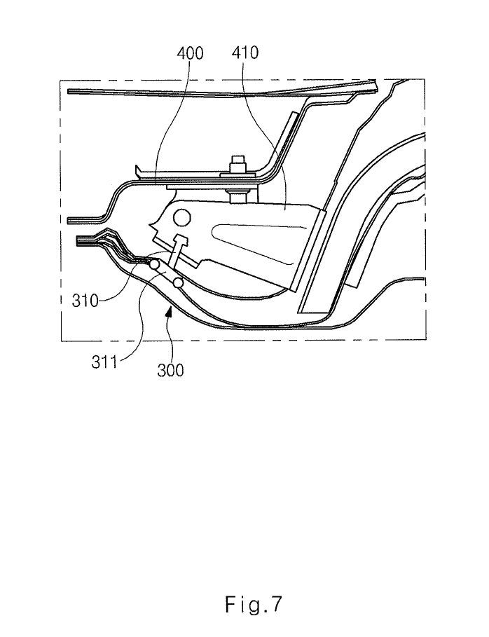

As illustrated in FIGS. 3 to 5, a sliding door structure according to various embodiments of the present invention includes a door panel member 100 slidably provided at the sliding door, a pole 120 installed on the door panel member 100. Further, as illustrated in FIGS. 6 to 8, a sliding door structure according to various embodiments of the present invention includes a pole 310 installed on a side panel 300, a door panel member 400 including a roller arm 410, and an inserting hole 411 formed at the roller arm 410 and inserted with the pole 310. Accordingly, the sliding door structure may prevent separation from the vehicle when the sliding door for the vehicle opens and closes.

As illustrated in FIGS. 3 to 5, the door panel member 100 includes a door inner panel 101 and a door latch reinforcement 102, which forms a slidable door.

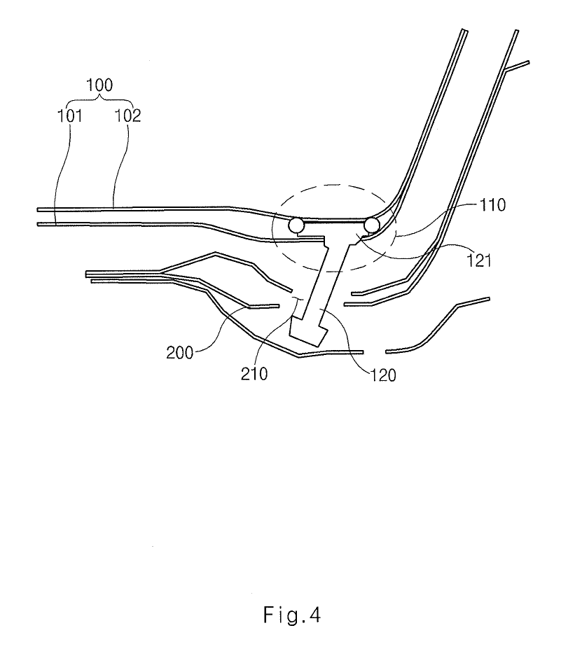

The door panel member 100 has a refractive part 110 (see FIG. 4), and a predetermined space between the door inner panel 101 and the door latch reinforcement 102 is formed in a longitudinal direction of the vehicle at the door panel member 100 with the refractive part 110.

The pole 120 protrudes from the refractive part 110 of the door panel member 100 to be inserted into the inserting hole 210 of the side panel 200 and as a result, the vehicle body may be locked with the sliding door for the vehicle.

Here, a plate 121 is additionally installed in the predetermined space formed between the door inner panel 101 and the door latch reinforcement 102, and the pole 120 is installed on one end of the plate 121 and protrudes outside to improve a coupling force between the pole 120 and the door panel member 100.

In this case, the door inner panel 101, the door latch reinforcement 102, and the plate 121 may be coupled with each other by welding.

The side panel 200 is a panel forming the side of the vehicle body and corresponds to the door panel member 100.

Here, the inserting hole 210 is formed in the side panel 200 to allow the pole 120 installed on the door panel member 100 to be inserted.

Meanwhile, the pole 120 is installed to be inclined from the plate 121 to minimize interference when the door opens and closes, and the inserting hole 210 into which the pole 120 is inserted is also formed in a shape corresponding to the pole 120.

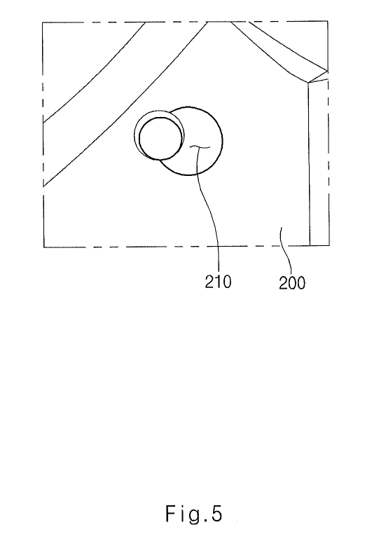

In this case, the inserting hole 210 is formed in a shape such as an infinity ∞ as illustrated in FIG. 5 to prevent the pole 120 from being locked when entering according to opening and closing of the door.

Further, an inner panel 201 is additionally installed on the inside of the side panel 200, and as a result, the pole 120 inserted into the inserting hole 210 of the side panel 200 may be not seen in the vehicle room.

Meanwhile, as described above, in various embodiments of the present invention, the pole 120 is installed on the door panel member 100 and the inserting hole 210 may be formed in the side panel 200, but in other embodiments, the pole 310 may be installed on the side panel 300 and the inserting hole 411 may be formed in the door panel member 400. A description of the various embodiments in this regard is as follows.

As illustrated in FIGS. 6 to 8, the pole 310 is installed on the side panel 300 forming the side of the vehicle body.

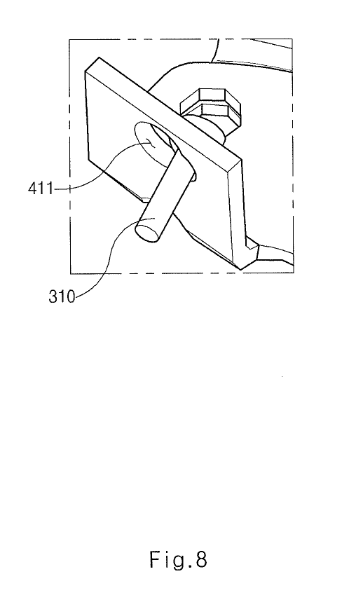

The pole 310 protrudes from the side panel 300 of the door panel member 400 to be inserted into the inserting hole 411 (see FIG. 8) formed in the roller arm 410 of the door panel member 400 and as a result, the vehicle body may be locked with the sliding door for the vehicle.

The door panel member 400 forms a slidable door and includes a roller arm so as to be slid along the side panel 300.

Further, the inserting hole 411 (see FIG. 8) is formed in the roller arm 410 to allow the pole 310 to be inserted.

Here, a plate 311 is additionally installed in the side panel 300, and the pole 310 is installed on one end of the plate 311 and protrudes outside the side panel 300 to improve a coupling force between the pole 310 and the side panel 300.

In this case, the side panel 300 and the plate 311 may be coupled with each other by welding.

Meanwhile, the pole 310 is installed to be inclined from the plate 311 to minimize interference when the door opens and closes, and the inserting hole 411 into which the pole 310 is inserted is also formed in a shape corresponding to the pole.

In this case, the inserting hole 411 is formed in a shape such as an infinity ∞ to prevent the pole 310 from being locked when entering according to opening and closing of the door.

As set forth above, according to various embodiments of the present invention, it is possible to improve marketable quality and safety and ensure rigidity to increase performance of a vehicle body by preventing separation from a vehicle when a sliding door for the vehicle opens and closes.

For convenience in explanation and accurate definition in the appended claims, the terms front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A sliding door structure for a vehicle, comprising:
a door panel member including an inner door panel and a door latch reinforcement, having a refractive part, and slidably provided in a sliding door of the vehicle;
a pole installed at the refractive part of the door panel member; and
a side panel corresponding to the door panel member, provided on the side of the vehicle, and having an inserting hole into which the pole is inserted.

2. The sliding door structure for a vehicle according to claim 1, wherein an inner panel is installed on the inside of the side panel.

3. The sliding door structure for a vehicle according to claim 1, wherein a plate is additionally installed on the door panel member, and the pole is installed on the plate.

4. The sliding door structure for a vehicle according to claim 3, wherein the pole is inclined with respect to the plate, and the inserting hole is formed in a shape corresponding to the pole.

5. A sliding door structure for a vehicle, comprising:
a pole installed on a side panel;
a door panel member including a roller arm so as to be slidable along the side panel; and
an inserting hole formed in roller arm into which the pole is inserted.

6. The sliding door structure for a vehicle according to claim 5, wherein a plate is additionally installed on the side panel, and the pole is installed on the plate.

7. The sliding door structure for a vehicle according to claim 3, wherein the pole is installed to be inclined to the side panel, and the inserting hole is also formed in a shape corresponding to the pole.
